(19) United States
(12) Patent Application Publication
(10) Pub. No.: US 2008/0283631 A1
(43) Pub. Date: Nov. 20, 2008

(54) Shower Head

(76) Inventors: Markus Wohrle, Schiltach (DE); Ulrich Kinle, Schenkenzell (DE)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/915,802

(22) PCT Filed: May 20, 2006
(86) PCT No.: PCT/EP2006/004809

§ 371 Date: Jan. 28, 2008

(30) Foreign Application Priority Data
Jun. 1, 2005 (DE) 10 2005 026 668.1

(51) Int. Cl. B05B 3/04

(52) U.S. Cl. 239/381

(57) ABSTRACT

A shower head according to the invention comprises a rotor with a closing plate which bears against a jet disk with jet passage openings and, when the rotor is rotated, alternately opens and closes said jet passage openings. Pulsed massage jets are generated at the outlet of the jet passage openings as a result. A further jet outlet disk with jet out let openings is arranged downstream of said jet disk, with said jet outlet openings being aligned axially opposite the jet passage openings of the jet disk. Ventilation chambers are arranged between the two disks, said ventilation chambers being connected to the outside of the shower head. The pulsed jets are ventilated downstream of the jet passage openings as a result.

The invention relates to a shower head for a massage spray.

The classical massage sprays are shower outlets in which a water jet is issued intermittently, wherein the jet exiting an opening is periodically interrupted. The massage effect it achieved in that individual pulses are applied to the skin.

Such interruption devices for generating massage jets are frequently installed inside the shower heads because they can also issue other jet types. Switchover devices for changing over between different types of water jets are provided directly on the shower heads.

In normal jet types, it is common to ventilate them. There are also shower heads in which normal types of water jets and massage jets can be issued. Here, it is common to provide ventilation upstream of the interruption device in order to ventilate the normal jets as well as the massage jets. However, this does not lead to particularly convenient results, since the effect of ventilation is negated by interruption under certain circumstances.

The object of the invention is to provide a shower head, wherein ventilated massage jets can be generated, which despite ventilation can still exercise their massage effect.

To achieve this object, the invention proposes a shower head with the features mentioned in Claim 1. Further developments of the invention are object of dependent claims.

This shower head, which can be used both as a shower head and/or as a part of a shower outlet with a switchover device, contains a means for generating intermittent or pulsed jets which come out of the jet passage openings of a jet disc. Viewed in the flow direction behind these jet passage openings, these massage jets are now ventilated with the help of the ventilation device. It has surprisingly come about that this type of ventilation leads to a good and effective result.

This type of ventilation of massage jets can be applied to all types of generation of pulsed jets. For instance, the device can feature a closing element for alternate opening and closing of the jet passage openings for generating pulsed massage jets.

This closing element, for instance, can be continuously movable, thus it can move in a continuous motion. For this purpose, a rotor can be used as a drive that can be driven by the water flowing through the shower head.

In particular, it can be provided according to the invention that the closing element, for instance a closing plate, is located in the flow direction in front of the jet outlet openings.

The ventilation device acting downstream of the jet passage openings can for instance feature at least one ventilation chamber that is located downstream of the jet passage openings. In this ventilation chamber, there is air that is sucked in by the massage jets flowing through the chamber.

In further developments of the invention, it can be provided that the shower head features a jet outlet disc downstream of said jet disc, which likewise features jet openings. Ventilation can be effective between these two discs. In particular, it can be provided that at least one ventilation chamber is located or formed between these two discs.

It can be provided that a single ventilation chamber is provided for all jet passage openings and all jet outlet openings. It is likewise, however, possible and proposed by the invention that the ventilation device features several ventilation chambers, which, if necessary, are uniformly distributed over the interstice between the two jet discs.

The already mentioned jet outlet disc contains the jet openings that are visible outwardly to the user. It covers the jet disc with the jet passage openings. According to the invention, it can be provided that the jet outlet disc features an axially oppositely oriented jet outlet opening for each jet passage opening. The jet outlet disc should as such be formed and located so that it does not disturb the now ventilated massage jets. It can therefore be provided that several jet passage openings are combined close together so that they practically form a closely contiguous bundle of jets. A larger jet outlet opening can be provided for such a bundle.

In a further development according to the invention it can be intended that for each jet passage opening or also for each group of jet passage openings an individual ventilation chamber is provided.

In a further development of the invention the supply of air to several ventilation chambers can take place from a common air chamber that is centrally located, which, in the case of a usually round jet, the outlet-disc should be located approximately in the middle between the two jet discs. This common air chamber can feature a connection to the outside of the shower head housing, for instance, in the middle of the jet outlet disc. It is also possible to let out this outwards connection at different points.

A further possibility proposed by the invention consists of allowing the air supply to several ventilation chambers to occur separately, for instance for each ventilation chamber, radially from outside of the shower head housing.

In the case of a central air supply to a central air chamber, the arrangement of a shut-off valve for shutting off the air supply is particularly simple in design.

Further features, details and preferences of the invention are derived from the claims and the abstract, of which the wording refers to the content of the description, and of the following description of a preferred embodiment of the invention as well on the basis of the drawing. The following figures show:

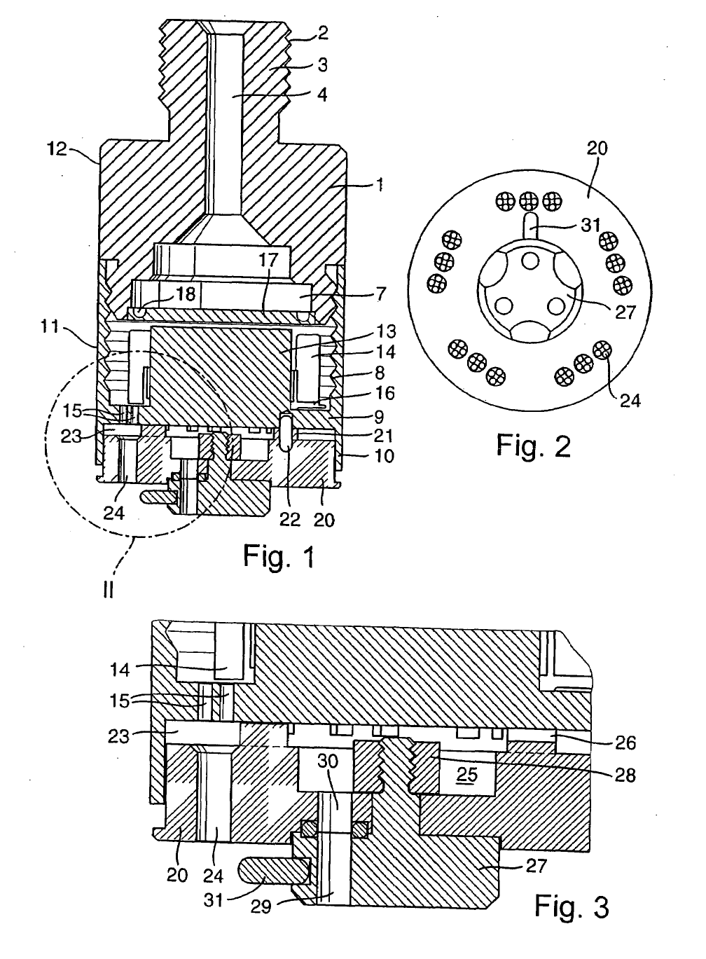

FIG. 1 an axial section through a shower head according to the invention;

FIG. 2 a face view of the shower heads from the bottom in FIG. 1;

FIG. 3 a detail view of the axial section of FIG. 1, in a magnified scale.

The shower head depicted in a simplified and schematic form in FIG. 1 contains a basis 1 that contains a pipe piece 3 with an outer thread 2. This pipe piece 3 is meant to be screwed in a supply line, or to be connected with a supply hose. A water supply 4 in the form of an axial channel is provided in the pipe piece 3. The basis 1 ends in a protrusion 5, which likewise features an outer thread 6. The water guide 4 expands up to this protrusion 5, where the water guide transforms into a flat cylindrical area 7.

A component part 8 is screwed on the basis 1 of the shower head housing that is formed as a sleeve with a bottom 9. A further sleeve section 10 connects to the bottom 9. The outer jacket surface 11 of the component part 8 runs flush with the jacket surface 12 of the basis part 1.

A bearing point 13 is formed on the bottom 9 of the component part 8 that supports a rotor 14. The bottom 9 contains an area that surrounds the outside area in a ring shape, in which a plurality of jet passage openings 15 is formed. These run in axial direction of the shower head. The bottom 9 thus forms a jet disc in this ring-shaped outer area.

A closing plate 16 lies on the inner side of this jet disc 9 facing towards the water guide 4 that extends outside over a part of the circumference of the supporting pipe piece 13. The closing plate 16 is connected with the rotor 14 as a single piece, so that it is moved with the rotor 14, in case this is rotated about the support pipe piece 13.

In the end of the protrusion 5 of basis 1 a circuit board 17 is fitted, which features passage openings 18 running askew in the area of its circumference. These are oriented towards the wings of the pipe 14 and all run askew in the same direction so that the water flowing through the openings 18 set the rotor 14 in rotation. By these means, the closing plate 16 opens and closes the jet passage openings 15 in the bottom 9 of the component part 8.

As a result of opening and closing of the jet passage openings 15 in the bottom 9 of the component part 8 forming the jet disc, 15 pulsed-massage jets are provided on the output side of the jet passage openings 15.

Downstream of the bottom 9 a jet outlet disc 20 is inserted in the pipe piece 10. This jet outlet disc 20 lies on the face surface of the jet disc formed by the bottom 9 with protrusions 21. At least one axial pin 22 for positionally correct alignment of the jet disc 20 relative to the bottom 9 is provided.

Between the bottom 9 and the side facing the bottom 9 of the jet disc 20 individual ventilation chambers 23 are formed, which directly adjoin on the outlet of the jet passage openings 15. The jet outlet disc 20 contains jet outlet openings 24 in the form of axially running bores in the axial extension of the jet passage openings 15. Further details can be derived from FIG. 3. In the middle of the jet disc 20 it contains middle cutouts 25 on its inner side facing the bottom 9, which form an air chamber. From this air chamber 25, radially running channels 26 lead to the already mentioned ventilation chambers 23 between the bottom 9 and the jet outlet disc 20. The channels 26 run radially from inside outwards.

In the middle of the jet outlet disc 20 a rotary element 27 is pivoted, which is screwed in the air chamber 25 in a nut 28. The rotary element 27 contains an eccentric passage opening 29, which in the depicted position is in connection with a passage opening 30 of the jet outlet disc so that an air guide from outside of the shower head housing is provided in the air chamber 25. By rotating the rotary element 27, supported by the activation pipe piece 31, the alignment of these passages can be negated so that no more air penetrates into the air chamber 25.

FIG. 2 shows a face view of the arrangement of FIG. 1 in the same scale as FIG. 1. The jet outlet openings 24 of the jet disc 20 features a diameter that is so large that four jet passage openings 15 are combined to a bundle that lies within such a jet outlet opening 24.

Through the water that enters the shower head, the rotor 14 is set in rotation so that the closing plate 16 opens and closes the jet passage openings 15 in the flow direction. In this manner, pulsed jets occur in every jet passage opening 15, which is ventilated downstream of these openings in the ventilation chamber 23.

1. A shower head for a massage spray, comprising:
a shower head housing,
a jet disc having jet passage openings located in the shower head housing,
a device located in the shower head housing for generating pulsed massage jets exiting the jet passage openings, and
a ventilation device for ventilating the massage jets exiting jet passage openings.

2. A shower head according to claim 1, wherein the device for generating pulsed massage jets comprises a closing element operable for alternately opening and closing the jet passage openings.

3. A shower head according to claim 2, wherein the closing element is continuously movable.

4. A shower head according to claim 2, wherein the closing element is drivable by a rotor.

5. A shower head according to claim 2, wherein the closing element executes a wobbling motion.

6. A shower head according to claim 2, wherein the closing element in a flow direction is located in front of the jet passage openings of the jet disc.

7. A shower head according to claim 1, wherein the ventilation device has at least one ventilation chamber that is located downstream, in a flow direction, of the jet passage openings of the jet disc.

8. A shower head according to claim 1, wherein a jet outlet disc is located downstream, in a flow direction, of the jet disc, and ventilation is effected between the two jet discs.

9. A shower head according to claim 8, wherein at least one ventilation chamber is located between the two discs.

10. A shower head according to claim 6, comprising a plurality of ventilation chambers.

11. A shower head according to claim 7, wherein the jet outlet disc for each jet passage opening has a jet outlet opening oriented axially opposite the jet passage opening.

12. A shower head according to claim 6, wherein an individual ventilation chamber is provided for each jet passage opening.

13. A shower head according to claim 6, wherein an individual ventilation chamber is provided for each group of grouped ones of the jet passage openings.

14. A shower head according to claim 9, wherein air supply to several said ventilation chambers occurs from a common air chamber (25).

15. A shower head according to claim 9, wherein air supply to several ventilation chambers occurs separately.

16. A shower head according to claim 1, further comprising a shut-off valve for shutting-off an air supply to the ventilation device.
